(19) United States
(12) Patent Application Publication
(10) Pub. No.: US 2019/0362371 A1
(43) Pub. Date: Nov. 28, 2019

(54) UNIQUE PRICING ENGINE

(71) Applicant: SHAWN HUTCHINSON, HARPERS FERRY, WV (US)

(72) Inventor: SHAWN HUTCHINSON, HARPERS FERRY, WV (US)

(21) Appl. No.: 16/467,775

(22) PCT Filed: Dec. 8, 2017
(86) PCT No.: PCT/US2017/065313

§ 371 Date: Jun. 7, 2019

Related U.S. Application Data
(60) Provisional application No. 62/432,528, filed on Dec. 9, 2016.

(51) Int. Cl. G06Q 30/02

(52) U.S. Cl. CPC G06Q 30/0206; G06Q 30/0278

(57) ABSTRACT

Methods for generating pricing for a product or service according to customer-specific information that is used to calculate a unique price for a service comprising using a Unique Pricing Engine, obtaining parameters from a service provider for the service, obtaining parameters for the service from a customer, setting a benchmark for the price of the service, calculating and generating the unique price for the service with the parameters of the service provider, and providing the unique price of the service to the customer.

### FIELD OF THE INVENTION

The invention relates to methods of generating unique pricing for products and services as well as to financial services that implement shared resources.

### BACKGROUND OF THE INVENTION

Numerous ways of generating customized pricing exist in the marketplace. However, there lacks a method of providing unique pricing for products and services according to the customer. Customized pricing, however, seeks to provide tailored prices for customers according to strategies that are determined by inventory, bulk discounts, supply chain costs, pricing plans, class plans, category plans, pricing tables, and coupons. Such prices may be referred to as customized, personalized, tailored, optimized, intelligent, group, sales, markup, markdown, adjusted, discounted, dynamic, and/or prioritized pricing. In contrast, unique pricing provide prices for products and services that are unique to the customer.

### SUMMARY OF THE INVENTION

A Unique Pricing Engine generates pricing for a product or service according to customer-specific information that is used to calculate a unique price. Furthermore, manufacturers, merchants, wholesalers, producers, retailers, and suppliers may also provide unique prices that provide their products and services a competitive advantage. Namely, a provision of cost buffering allows the unique price that a customer pay to be lower than a price competitor. The unique pricing engine may hold a cost buffering resource that subsidizes prices for customers. Furthermore, the cost buffering resource is supplied with resources that may be monetized and reduce the price that customers pay. Such resources that supply cost buffering include, and are not limited to, automated bartered goods and services, optional price overrides for customers who select performance pricing strategies, credit systems that count sales towards rewards, volumetric cost derivatives, as well as through direct monetary contributions. The resource buffering resource allows the engine to set pricing points that are generated according to desired ranges for a merchant service. The unique price presented to a customer may be higher or lower than a customized price.

In preferred embodiments, the unique pricing engine generates a price for a product or service that is unique for the customer of that product or service. The price offered to the customer is calculated according to parameters set by both the manufacturers, merchants, wholesalers, producers, retailers, and suppliers as well as the customer. The parameters that a customer sets include, for example, cost of living, standards of living, local standards, aggregate standards, family status, marital status, education level, amount of time, time of day, availability, per diem, income level, tax bracket, ZIP code, extended ZIP, volume of transactions, profit margin, and a charitable giving option. Parameters may also be set on behalf of the customer, and vice versa. In some cases the provider of a product or servicer may also set identical or similar parameters. A customer could be an individual, collective, coop, group, or a legal entity such as a corporation. The parameters that an entity customer or provider sets include, for example, actuarial metrics, customer analytics, market discounts, tariffs, surges tax credits, tax strategies, investment strategies, numbers of transactions, pricing agreements, inventory, supply, demand, transaction costs, advertisement analytics, performance analytics, click metrics, and so on.

The unique pricing engine allows the manufacturers, merchants, wholesalers, producers, retailers, and suppliers to set their own costs. The aforementioned systems for determining such pricing-customized, personalized, tailored, optimized, markup, markdown, adjusted, discounted, dynamic, and/or prioritized pricing-may provide their settings. While the unique pricing that is generated by the engine may also be factored into the pricing systems. The purpose of the unique pricing engine is to provide competitive advantages to both the customer and to the manufacturers, merchants, wholesalers, producers, retailers, and suppliers. The benefits of the engine include increased revenue, marketing incentives, brand recognition, improvements for the social good, and strategic development of branding.

### BRIEF DESCRIPTION OF THE DRAWINGS

FIG. 1. A Unique Pricing Engine. Components of a Unique Pricing Engine are illustrated.

FIG. 2. Graphical User Interfaces. Exemplary Graphical User Interfaces are illustrated for customer and provider inputs.

FIG. 3. Digital System Embodiment. A sample illustration of a Digital System that implements a Unique Pricing Engine.

FIG. 4. Merchant Seller Embodiment. Comparative flow charts for a standard merchant seller website and a merchant seller that implements a Unique Pricing Engine.

### DETAILED DESCRIPTION OF THE INVENTION

A Unique Pricing Engine can preferably be configured through a graphical user interface that allows a customer to set the factors that are used to generate the unique price. A customer creates an account and registers their personal identity information. The interface provides input fields for the customer to specify information that is public, sensitive, and/or private. For example, the customer inputs the name, age, marital status, number of children, tax bracket, taxable income, education level, and zip code. The engine gathers personal, quantified, and statistical information related to the customer, the neighborhood, city, and state. More detailed information may also be provided according to tax transcripts, liens, debt accounts, credit report, credit score, driver's license, insurance history, background check, behavioral metrics, click history, and other data metrics that allow a customer's context, resources, identity, and habits to be articulated in parametric form. These detailed data about a customer are used to calibrate the purchase capacity of a customer for a given product.

In a preferred embodiment, a user registers at a digital interface to the Unique Pricing Engine and provides data in the input fields. Parameters are used to determine a variable pricing index. An index is generated with the data from the input fields. For example, a customer having a large family with an income that is on par with the national average may have an index greater than a set pricing threshold. A set pricing threshold may be a simple price of good sold before fees are calculated for taxes, shipping, handling, and/or connectivity fees. A set pricing threshold may be used to allow a customer or a provider to request a price engine alteration, to set a price limit, redisplay prices with or without fees, price bidding, peer group combined purchasing, collective purchasing, bulk discounting, surge pricing, increase/decrease gift levels, and priority purchase positions. A customer index then may be used to reduce the price of a product. Another customer may have an income higher than the national average and have fewer dependents. In this case the customer index increases the price paid for a product. The price paid could be higher or lower than a benchmark price that a provider sets. The resource buffer account may be debited or credited according to the price paid for a product or service by a customer. A customer's input factors are used to calculated a weight, coefficient, variable, or numerical factor to the pricing index according to a customer's purchasing capacity, local standards affordability, risk factor, and customer history. Furthermore, a pricing index could be generated according to aggregate standards, socio-economic statistics, demographics, housing metrics, or other impersonal sources of data that may be used to further resolve or float the unique price that a customer pays for a product or service.

A customer pricing index may be a multiplicative coefficient or denominator value that allows the product price to be determined according to the unique personal identity information. The numerical value of the data input into these fields may increase or decrease a variable pricing index. The engine may implement multiple pricing indices for a customer according to the cost of a product. These data inputs may be stored in an account, on a portable data device, a chip card, a magnetic strip card, or may be inputted on demand. The data may be stored and accessed when needed, only one time, or used a set number of times.

A provider such as a manufacturers, merchants, wholesalers, producers, retailers, seller, suppliers, or servicer registers data inputs relating to the price of a product or service. The data could be a benchmark price of a product. The pricing data may also be a price determined according to aforementioned methods and systems that calculate prices according to customized, personalized, tailored, optimized, markup, markdown, adjusted, discounted, dynamic, and/or prioritized pricing. A benchmark price may be determined according to inventory, bulk discounts, supply chain costs, and pricing plans. Moreover, a provider may input similar or identical information that a customer provides in order to determine a provider pricing index. A provider pricing index may be specific for an individual or entity. The pricing index may be increased or decreased according to the provider's selling capacity, local standards affordability, advertising, sales and marketing, incentives, risk factor, and sales history.

For servicers, the provider pricing index allows individuals and entities to increase or decrease a price for a product or service according to name, age, marital status, number of children, tax bracket, taxable income, education level, and zip code. More detailed information may also be provided according to tax transcripts, liens, debt accounts, credit report, credit score, driver's license, insurance history, background check, behavioral metrics, click history, and other data metrics that allow a provider's context, resources, identity, and habits to be articulated in parametric form.

A provider pricing index may be a multiplicative coefficient or denominator value that allows the product price to be determined according to the unique personal identity information. The numerical value of the data input into these fields may increase or decrease a variable pricing index. The engine may implement multiple pricing indices for a provider according to the cost of a product. These data inputs may be stored in an account, on a portable data device, a chip card, a magnetic strip card, or may be inputted on demand. The data may be stored and accessed when needed, only one time, or used a set number of times.

The Unique Pricing Engine may be accessed through a graphical user interface on a third-party website, through an Application Protocol Interface (API) that integrates the functionality into an existing website, through a back-end calculation system that generates customized pricing, or through a portable payment device for use at a point of sale system or as a point of purchase system. A point of purchase system processes sales on behalf of a seller to one or more seller, manufacturer, merchant, wholesaler, producer, retailer, and supplier. Such portable payment device, purchase card, or point of purchase device may furthermore include a smartphone, credit card, push-button payment system, or click channel that performs, initiates, connects, or completes a transaction for a sale, order, refund, automated clearinghouse, or any such merchant transaction. In another preferred embodiment, the Unique Pricing Engine is a calculation layer called by an API that may be instantiated at any point or points in the purchase-sale transaction sequence starting from raw materials and completing in product delivery. The Unique Pricing Engine may also preferably be a calculation layer called by an API that may be instantiated at any point or points in the purchase-service transaction sequence starting from initiation of service request and completing of service rendering.

The Unique Pricing Engine may be implemented in such a way that the resource buffer is held for specific individuals, entities, or common amongst individuals and/or entities. For example, a large seller of products may instantiate one or more resource buffers in order to distribute funds from the same of one product category or another. A larger seller could increase prices according to market demand in order to offset costs in other product or service areas. Rather than providing access to resources that could be used as coupons, by comparison, the resource buffer may be available to customers who meet certain parametric criterion. The parametric criterion in this case may be the personal set of financial information such as for example taxable income, standard of living, cost of living, and family status. One of the uses of the engine would be to subsidize the cost of staples that a customer might otherwise not be able to afford. Staple products could be easily be subsidized such as paper products, disposables, comestibles, commodity, and sundry items. A large seller or products could supply resources to a buffer from a manufacturer, internal purchase incentives, through government subsidies, as well as through direct contributions from other customers.

A resource buffer may be implemented with a standard banking accounting system, automated clearinghouse, point of sale system, user interface, and/or a banking API. The resource buffer may be held within a user interface of the Unique Pricing Engine, accessible through it, or external to it. A number of buffers may be used for various products or services, at the discretion of the provider or customer. The resource buffer may also be implemented by the customer in order to budget expenditures. The resource buffer may be implemented to provide parental and guardian controls, supplying of allowance resources, and tracking of expenses and/or purchases.

The supply and demand placed on a resource buffer for resources could be supplied from purchases of durable goods as well as titled and deeded assets. A nonprofit, municipality, religious organization, and/or governmental agency could organize a fund that is used for customers of specific zip codes and demographics in order to subsidize specific product purchases or services. Products need not be limited to staples and commodities. A for-profit organization could give a portion from their revenue towards a resource buffer from profits, advertisement revenue, earnings, and investment income. In an exemplary embodiment, retailers can integrate a unique pricing engine into their point of sale system, implement the Unique Pricing Engine as a point of purchase system, implement a cloud system for access to the Unique Pricing Engine, and/or implement a portable purchase device that generates unique prices for products and services at checkout. Rather than paying averaged retails prices for products, the Unique Pricing Engine in this preferred embodiment generates prices for each product that is purchased according to the resources of the customer. Organizations who offer a resource buffer would find advantages that are useful in attracting customers to a retail site, website, or through brand recognition, for their practice of providing support for customers whose resources are to varying degrees limited. The implementation of a Unique Pricing Engine could improve the click conversion ratio. Similarly, manufacturers, merchants, wholesalers, producers, and suppliers could implement an engine and/or buffer. Service providers could implement an engine and/or buffer for social services, internet services, cable services, delivery services, transportation services, subscriptions, insurance services, mental health services, physical health services, housing services, and health services in general.

In another preferred embodiment, the Unique Pricing Engine may be used to provide unique prices to customers according to an aggregate, a gauged, predicted, forecasted, behavioral, or set parameters. In a preferred embodiment, a seller of products provides an option to a customer to purchase at a price point higher than the average or customized price. Customers may have personal incentives to contribute in an altruistic or charitable manner to the benefits of others. A seller of products could create funds that are collected for altruistic price overrides wherein customers pay a top marginal price offset that is made available in the resource buffer for customers who may not otherwise purchase a product or as much of a product. A seller of products could create a charitable fund that collects donations and gifts on behalf of persons with restricted resources to include those of impoverished means, fixed income, limited income, disability, autistic, or other disposition that renders a person unable to earn or produce at a level that supports their well-being. Similarly, a service organization may also utilize a resource buffer in order to collect resources, distribute, redistribute, and/or subsidize the cost of services according to customer settings.

A preferred digital system embodiments of the Unique Pricing Engine also include a portable payment device that either holds in a data card having the input data from the customer, a pricing index, and/or connectivity to the a server or cloud system. The device may be a smart phone, credit card, chip card, or mobile point of sale device. A payment device may also have a resource buffer. A point of sale device may link to a server or inventory system that contains itemized records for goods or products. The point of sale device communicates with the portable payment device in order to generate unique prices for the products purchased. The point of sale device communicates with the Unique Pricing Engine through a computer, server, or cloud system in order to calculate a unique price or prices. The engine may be implemented as an automated clearinghouse that reconciles accounts with the payment for products sold and the resource buffer. The engine may communicate with a batch processing system in order to reconcile accounts for products sold and the resource buffer. The Unique Pricing Engine may comprise an account number and routing number for use with banking and/or credit card systems. A cloud system may host or communicate through an API with the Unique Pricing Engine, one or more resource buffers, a virtual point of sale system, the portable payment device, and merchant payment accounts.

A digital system may also be implemented for services as well as combinations of products and services. For example a Resource Card or a Reference Card may be used by the customer rather than a Credit Card in order to pay for services. A resource buffer or buffers may be linked with the card in order to determine unique prices for services. The buffer could be linked to insurance cost matrices, look-up tables, actuarial calculations, plan coverages, and the like that calculate reductions in prices according to insurance package. The buffer could be linked to a Health Savings Account in order for account for costs covered by insurance or that are tax deductible and those that are not. The Unique Pricing Engine in this case serves as an intermediary between the customer, the insurance plan/company, as well as the service provider in order to determine costs, process transactions, as well as to credit and debit resource accounts accordingly. The digital system could be communicative with an Application Programming Interface to a credit transaction system in order to process payments from one or more accounts and/or resource buffers. A user interface could be accessible to the customer in order to track purchases, accounting, tax deductions, credit/debit their resource buffer/s. An insurance company may be a private company or a public government organization such as Medicare, Medicaid, or Social Security. The insurance company may provide resources in a buffer from third-party sources, government funding, gifts, loyalty points, incentives, cash rewards, etc. The resource buffer could be used as in incentive for insurance companies to reward customers for maintaining good health or good performance records. A resource buffer could be linked with biometrics and health maintenance programs. Performance records could be linked with health, driving, auto insurance, home owners insurance, and bundled services. Unique Pricing Engine interfaces between one or more insurance, provider agencies, customers, servicers, providers, parents, and dependents.

A merchant preferred embodiment allows a seller to expand the audience of customers, incentive structures, advertising revenue, and the programs designed to assist customers. The seller implements a digital system as defined above. A web portal allows the seller to offer unique prices to the customer for each and every product or service offered. The customer may input settings into their seller account for a Unique Pricing Engine. The seller may link the customer account to a central Unique Pricing Engine interface. The seller may implement one or more resource buffers. Resource buffers may be opened according to product family, brand, category, manufacturer, or supplier. Resource buffers may be opened for advertising purposes wherein resources are paid or given for a product in order to generate a unique price that is specific for each customer. The customer pricing index may be useful in order to fine-tune the amount from a resource buffer provided to subside the purchase prices of a product or service. The customer pricing index may be useful in order to offset the price higher than the benchmark price in order to collect top margins from product purchases used to subsidize purchases by specific customers according to their pricing input settings. The seller may automate provision of a resource buffer according to purchase history, volume pricing, click analytics, navigation cookies, advertising resources, sales, and incentive programs. The Unique Pricing Engine provides an attractor for customers to see their unique price. The Unique Pricing Engine provides a service that is advantageous for sales and marketing for the common good, charitable purposes, and/or human good. A seller may utilize one or more tax-deductible, charitable giving, contributions from third-parties, and income revenue sources for resource buffers. The seller may develop provider pricing indices according to desired thresholds and levels of pricing points. The seller may develop customer pricing indices according to desired thresholds and levels of pricing points. The seller and the product representative may develop special indices for partnerships, seasonal sales, incentives, volume derivatives, and/or package bundles. The seller may provide incentives for streamlined production, integrated supply chains, favorable status, country of origin, trade standards, manufacturing standards, and production metrics towards pricing indices and resource buffers. The seller develops brand recognition and public trust for use of the engine, buffers, and indices.

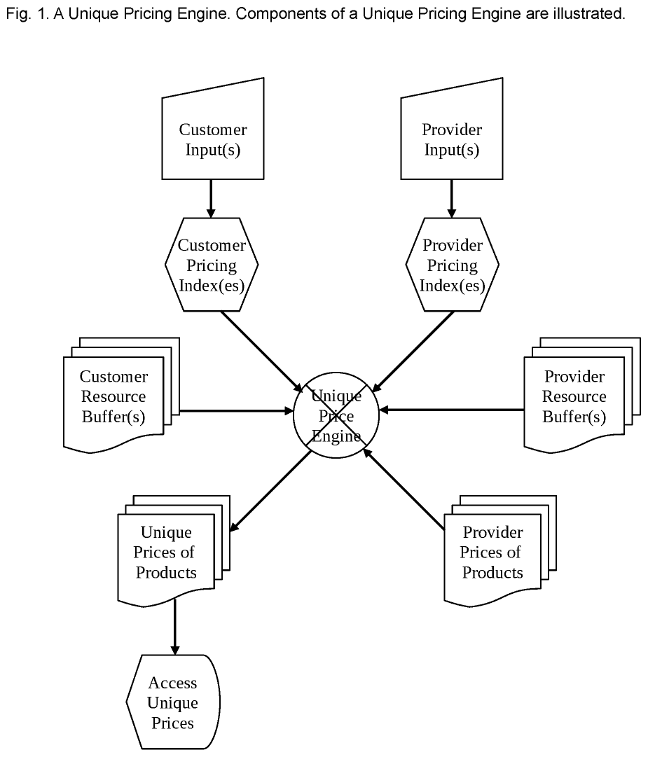

FIG. 1. A Unique Pricing Engine receives inputs from customer and a product provider such as a seller. Pricing indexes are determined for the customer and seller according to the inputs. Resource buffers for one or more of the customer and seller comprise monetary resources that buffer the difference between the seller price and the unique price paid by the customer. A Unique Pricing Engine determines unique prices for one or more products using the one or more resource buffers. The unique prices are displayed to the customer. Unique prices could be greater than or less than the provider set prices. A product purchase transaction is processed for the customer according to the unique price for one or more products. After one or more products are purchased by the customer, the resource buffers are then credited and/or debited accordingly.

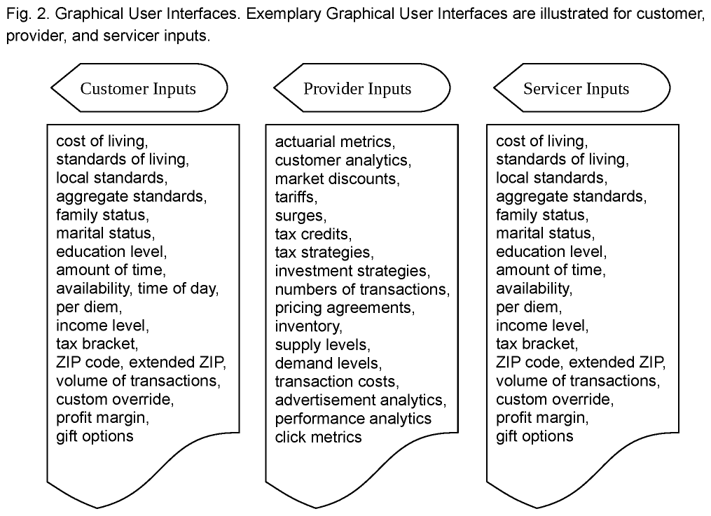

FIG. 2. Graphical User Interfaces. Exemplary Graphical User Interfaces are illustrated for customer, servicer, and provider inputs. Inputs are used to determine pricing indexes for a customer, service, and/or provider. Inputs may include one or more the following, as well as other quantified parameters that distinguish the uniqueness of a customer, provider, and/or servicer.

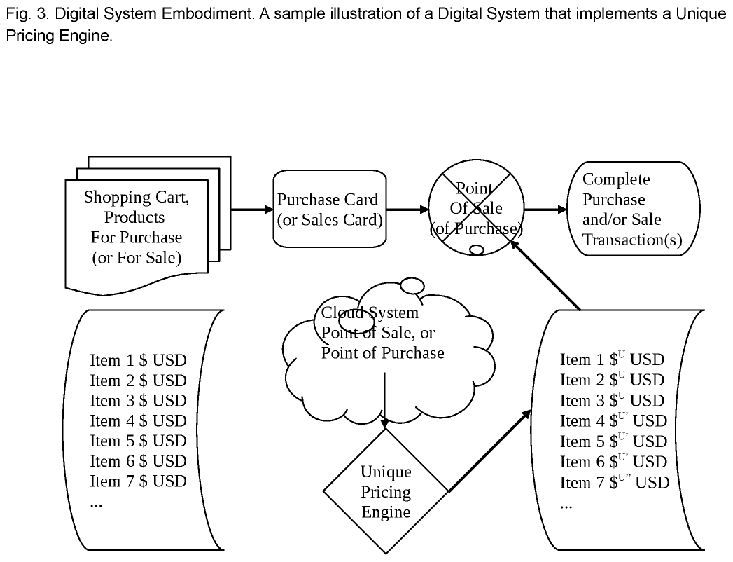

FIG. 3. A sample illustration of a Digital System that implements a Unique Pricing Engine. A customer has as shopping cart comprising items for purchase. A purchase card is presented to a point of sale system for purchase. Alternatively a sales card is presented to a point of purchase system for selling one or more products to one or more seller, manufacturer, merchant, wholesaler, producer, retailer, and supplier. The point of sale device decisions with regards to the use of the card, sends the product SKU and customer identifier a cloud implemented Unique Pricing Engine. The Engine responds with a list of unique prices according to one or more pricing indices and/or thresholds. A product purchase transaction is processed for the customer according to the unique price for one or more products. After one or more products are purchased by the customer, the resource buffers are then credited and/or debited accordingly.

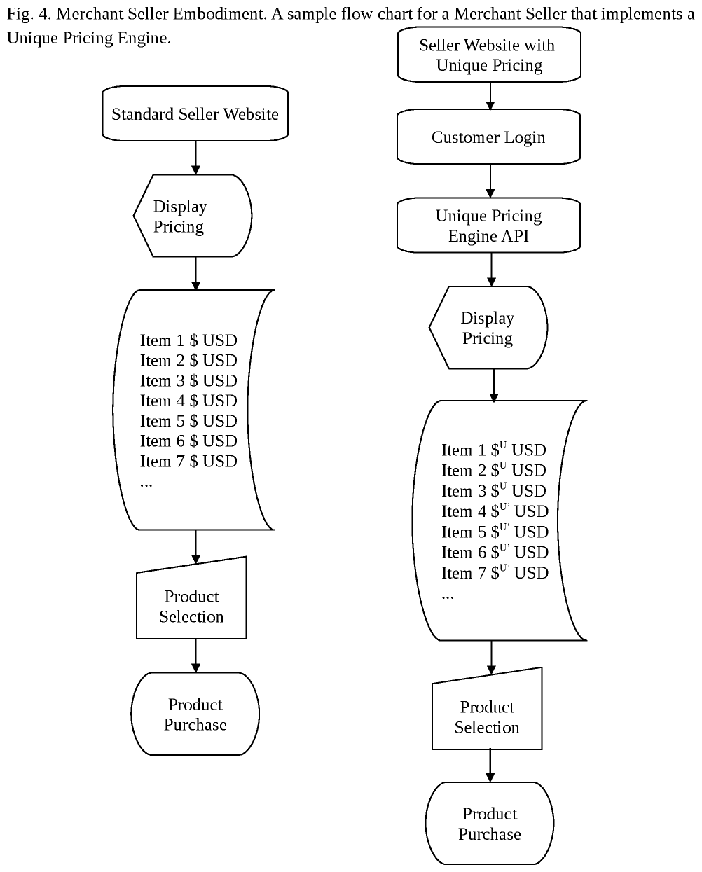

FIG. 4. Merchant Seller Embodiment. Comparative flow charts for a standard merchant seller website and a merchant seller that implements a Unique Pricing Engine. The standard seller website displays prices according to a standard price, such as a national standard price for a product and/or a service purchase in the United States. Customers select products for purchase, has tax and shipping fees added, and proceeds to a point of sale system for purchase. A merchant seller implementing a Unique Pricing Engine Application Programming Interface (API) provides a customer login. After logging into the seller website, the Unique Pricing Engine supplies customer index and resource buffer data to the website in order to determine unique prices for one or more products to the customer. Alternatively, the seller website may provide product SKU numbers and pricing information to a Pricing Engine and receive unique prices for one or more products and/or one or more services. A customer selects one or more products and/or one or more services for purchase. A product purchase transaction is processed for the customer according to the unique price for one or more products. After one or more products are purchased by the customer, the resource buffers are then credited and/or debited accordingly.

### Definitions

Unique refers a price that is generated for a specific person or entity. The numeric price may also be unique in that no two persons have the same price for a given product. A unique price may also encompass a fractional price that when modded or rounded appears to be similar or identical to a price offered to another customer.

Individuals are defined as a person. The Unique Pricing Engine provides a price that is unique for a particular person. Non-unique prices may be referred to as customized, personalized, tailored, optimized, intelligent, group, sales, markup, markdown, adjusted, discounted, dynamic, category, class, table, or prioritized pricing.

Entities are any legal entity having formed such as an incorporation, limited liability company, limited liability partnership, joint venture, corporation, and proprietorship, as well as foreign corporations and governmental agencies acting on the behalf of a state, people, or on behalf of corporations.

Per Diems are rates calculated by the U.S. General Services Administration. Other per diem rates may be included, as well as metrics that are more finely attuned to the cost of visiting localities.

Local Standards are rates calculated by the U.S. Internal Revenue Service. Other cost of living metrics may be included, as well as metrics that are more finely attuned to the cost of living in localities.

Aggregate Standards are metrics calculated according to demographics, statistics, averages, census, groups, categories, analytics, and the like. These may be public or private data sets that allow the Unique Pricing Engine to hone the price of a product or service for a customer as well as to finance one or more resource buffers.

Resource Buffer is a monetizable fund that may be used to supplement the price of a product or service. One or more resource buffers may be implemented in generating a unique price for a customer. A resource buffer may be internal to an organization or accessible from a third party.

Provider a manufacturer, merchant, wholesaler, producer, retailer, seller, supplier, and/or service provider. A provider may be a person and/or an entity.

Volumetric cost derivatives, quantified metrics that represent costs of production, manufacturing, shipping, supplying, sales, transaction, clicks, marketing, service, and any cost of good sold. These metrics may be in common to producers of a product, such as the cost of importing or of purchasing raw materials. The actions performed these producers may be provided by a third party servicer who provides the services at a competitive advantage. The ability of the third party servicer to forecast the future expenses of providing services to producers allows volumetric cost derivatives to be leveraged for price competitiveness.

1. A method of providing a unique price for a service to a customer, comprising:
Obtaining parameters according to a service provider;
Obtaining parameters according to a customer of a service;
Setting a benchmark price for a service;
Calculating a unique price for a service, further comprising
Generating a price for a service with parameters of a service provider; and
Generating a price for a service with parameters of a customer of a service;
Providing a unique price for a service to a customer.

2. The method of claim 1, wherein said parameters comprise at least one of a resource buffer, pricing index, cost of production, cost of delivery, cost of transaction, cost of living, standards of living, local standards, aggregate standards, family status, marital status, education level, amount of time, time of day, availability, per diem, income level, tax bracket, ZIP code, extended ZIP, volume of transactions, profit margin, and a charitable giving option.

3. A method of providing a unique price for a product to a customer, comprising:
Obtaining parameters according to a product;
Obtaining parameters according to a customer;
Setting a benchmark price for a product;
Calculating a unique price for a product, further comprising
Generating a price for a product with parameters of a manufacturer, retailer, or supplier; and
Generating a price for a product with parameters of a customer of a product;
Providing a unique price for a product to a customer.

4. The method of claim 1, wherein said parameters comprise at least one of a resource buffer, pricing index, cost of production, cost of delivery, cost of transaction, cost of living, standards of living, local standards, aggregate standards, family status, marital status, education level, amount of time, time of day, availability, per diem, income level, tax bracket, ZIP code, extended ZIP, volume of transactions, profit margin, and a charitable giving option.

5. Providing a unique price to a customer for a product or service wherein each customer obtains a unique price for a product or service generated according to at least one of a resource buffer, pricing index, cost of production, cost of delivery, cost of transaction, cost of living, standards of living, local standards, aggregate standards, family status, marital status, education level, per diem, income level, tax bracket, time of day, volume of transactions, and a charitable giving option.
